(19) United States
(12) Patent Application Publication
(10) Pub. No.: US 2011/0072129 A1
(43) Pub. Date: Mar. 24, 2011

(54) ICMP PROXY DEVICE

(75) Inventors: Jean-Francois Le Pennec, Nice (FR); Aurélien Bruno, Colomars (FR); Nicolas Grisi, La Colle sur Loup (FR)

(73) Assignee: AT&T INTELLECTUAL PROPERTY I, L.P., Reno, NV (US)

(21) Appl. No.: 12/613,692

(22) Filed: Nov. 6, 2009

(30) Foreign Application Priority Data
Sep. 21, 2009 (FR) 0956458

(51) Int. Cl. G06F 15/173

(52) U.S. Cl. 709/224; 709/238

(57) ABSTRACT

Provided are an ICMP proxy device, system and method of proxying. The ICMP proxy device includes a receive module, a protection determination module and a response module. The receive module is configured to receive a direct availability request addressed to a server from a host. The protection determination module is configured to determine whether the server is available. The response module configured to respond to the host with an availability response based the determination, such that the availability response is addressed from the server to the host.

### CROSS REFERENCE TO RELATED APPLICATIONS

This application claims priority to French Patent Application No. 0956458, filed on Sep. 21, 2009, the entirety of which is incorporated herein by reference.

### BACKGROUND

1. Field of Technology

The present application relates generally to Internet Control Message Protocol (ICMP). More particularly, the present application is directed to an ICMP proxy device, system and method directed to proxying ICMP traffic.

2. Brief Discussion of Related Art

The Internet Control Message Protocol (ICMP) is one of the core protocols in computer networking. The ICMP is chiefly used by network computers to send error messages, typically generated in response to errors in IP datagrams (as specified in RFC 1122—Requirements for Internet Hosts—Communication Layers), or for diagnostic purposes. Many important and commonly-used network utilities are based on ICMP messages.

For example, a Traceroute command is implemented by transmitting UDP datagrams with specifically set Internet Protocol (IP) time-to-live (TTL) header fields, and looking for ICMP TTL values in the header fields that have been exceeded in transit as well as “Destination unreachable” messages generated in response to these datagrams. The Traceroute command allows discovery or determination of the forward path, including the IP address of intermediate nodes as well as the time to reach each of intermediate nodes.

As another example, a ping tool sends ICMP Echo Request messages and receives ICMP Echo Response messages. It is used to determine whether a host is reachable and how long packets take to get to and from that host. As a further example, path Maximum Transmission Unit (MTU) discovery also uses the ICMP to negotiate the size of packets that can be sent during a session.

The ICMP facilitates the use of important utilities listed above, but it can also be manipulated by hackers. That is, some ICMP messages are necessary for network administration. Unfortunately, hackers have found ways to turn good network tools into attacks by using ICMP messages as vehicles for a variety of attacks against vulnerable targets.

For example, in an ICMP packet magnification or “smurf attack,” an attacker sends forged ICMP echo packets to vulnerable networks' broadcast addresses. All the systems on those networks send ICMP echo replies to a target system (the victim), consuming the target system's available bandwidth and creating a denial of service (DoS) to legitimate traffic. In a ping-of-death attack, the attacker sends an ICMP echo request packet that is larger than a maximum IP packet size to a target system. Since the ICMP echo request packet is larger than a normal IP packet, the ICMP echo request packet is fragmented. Because the target system cannot reassemble packets, the target system's operating system may crash or the target system may reboot.

In an ICMP “flood attack,” a broadcast storm of pings overwhelms a target system so it cannot respond to legitimate traffic. In an ICMP “nuke attack,” a packet of information is sent which an operating system of a target system cannot handle. In an ICMP “denial of service” (DoS) attack, an attacker could use either the ICMP “Time exceeded” or “Destination unreachable” messages. Both of these ICMP messages can cause a host to immediately drop a connection. For example, the attacker can simply forge one of these ICMP messages, sending the forged message to one or both of the communicating hosts. The connection between communicating hosts will then be broken. The attacker can also use an ICMP “Redirect” message. The ICMP “Redirect” message is commonly used by gateways when a host has mistakenly assumed that a destination is not on a local network. If an attacker forges an ICMP “Redirect” message, the attacker can cause another host to send packets for certain connections through the attacker's host.

Many ICMP attacks can be effectively reduced by deploying firewalls at critical locations of a network to filter unwanted traffic from suspicious destinations. This is known as ICMP “Attack Mitigation.” In addition, to keep a reasonable balance between services and security, network and system administrators may configure ICMP parameters in network devices by restricting some of their ICMP capabilities and responses. However, such attack mitigation may result in preventing important network utilities, such as ping or Traceroute, from answering ICMP messages.

### SUMMARY

In accordance with an embodiment, a method of proxying ICMP traffic is disclosed. The method includes the ICMP proxy device receiving a direct availability request addressed to a server from a host. The method also includes the ICMP proxy device determining whether the server is available. The method further includes the host from the ICMP proxy device responding with an availability response based on the determination, such that the availability response is addressed from the server to the host.

In accordance with another embodiment, a system of proxying ICMP traffic is disclosed. The system includes an ICMP proxy device. The ICMP proxy device includes a receive module, a protection determination module and a response module. The receive module is configured to receive a direct availability request addressed to a server from a host. The protection determination module is configured to determine whether the server is available. The response module configured to respond to the host with an availability response based the determination, such that the availability response is addressed from the server to the host.

In accordance with a further embodiment, a method of proxying ICMP traffic is disclosed. The method includes the ICMP proxy device receiving an indirect availability request from a web server. The indirect availability request is addressed by a host to the web server for a server associated with the web server. The method also includes the ICMP proxy device performing a direct availability request of the server and performing a direct availability request of the host. The method further includes the ICMP proxy device updating the web server with an availability response indicating availability of the server and the host. The web server is enabled to respond to the host with the availability of the server and the host.

In accordance with yet another embodiment, a system of proxying ICMP traffic is disclosed. The system includes an ICMP proxy device. The ICMP proxy includes a receive module, an availability request module and an update module. The receive module is configured to receive an indirect availability request from a web server. The indirect availability request is addressed by a host for a server associated with the web server. The availability request module is configured to perform a direct availability request of the server, and further configured to perform a direct availability request of the host. The update module is configured to update the web server with an availability response indicating availability of the server and the host.

In accordance with still another embodiment, a method of proxying ICMP traffic. The method includes the ICMP proxy device receiving an indirect availability request from a web server for a server associated with the web server. The ICMP proxy device performs a direct availability request for the server. The ICMP proxy device further performs a direct availability request for the web server. The ICMP procys device updates the web server with an availability response indicating availability of the server and the web server.

In accordance with a further another embodiment, a system of proxying ICMP traffic id disclosed. The system includes an ICMP proxy device. The ICMP proxy includes a receive module, a n availability request module and an update module. The receive module is configured to receive an indirect availability request from a web server for a server associated with the web server. The availability request module is configured to perform a direct availability request of the server, and further configured to perform a direct availability request of the web server. The update module is configured to update the web server with an availability response indicating availability of the server and the web server.

For a more thorough understanding, reference is made to the following description, taken in conjunction with the accompanying drawings, the scope of which will be defined in the appended claims.

### BRIEF DESCRIPTION OF THE DRAWINGS

Some embodiments are illustrated by way of example and not limitation in the figures of the accompanying drawings in which:

FIG. 1 is a high-level block diagram of an example computer system;

FIG. 2 shows an example process flow of a host performing a direct availability status request addressed to a first server protected by an ICMP proxy in the computer system of FIG. 1;

FIG. 3 is a flowchart of an example method of proxying a direct availability status request by an ICMP proxy device in accordance with FIGS. 1 and 2;

FIG. 4 is a high-level diagram of an example computer system;

FIG. 5 shows an example process flow of a host performing an indirect availability request via the web server of FIG. 4;

FIG. 6 is a flowchart of an example method of proxying an indirect availability status request via an ICMP proxy device in accordance with FIGS. 4 and 5;

FIG. 7 is a flowchart of an example method of performing an indirect availability status request via a web server in accordance with FIGS. 4 and 5; and

FIG. 8 is a block diagram of a general computer system.

### DETAILED DESCRIPTION

An ICMP proxy device, system and method of proxying ICMP traffic are disclosed. In the following description, for the purposes of explanation, numerous specific details are set forth in order to provide a thorough understanding of example embodiments. It will be evident, however, to one skilled in the art, that an example embodiment can be practiced without all of the disclosed specific details.

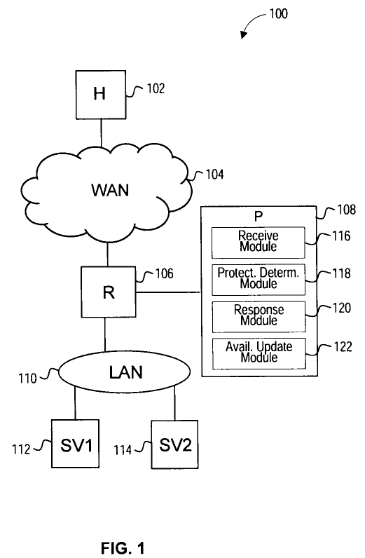

FIG. 1 is a high-level block diagram of an example computer system 100. The computer system 100 includes a host (H) 102, a router or switch (R) 106, an ICMP proxy device (P) 108, a first server (SV1) 112 and a second server (SV2) 114. The computer system 100 further includes a wide area network (WAN) 104 and a local area network (LAN) 110.

As shown in the computer system 100, the host 102 is operationally connected to the WAN 104. The host 102 can be connected to the WAN 104 either directly or through other networks. Although only the host 102 is shown in the computer system 100 of FIG. 1, it should be understood that the computer system 100 can include multiple hosts, similar to or different than the host 102, which can be operationally connected to the WAN 104. The WAN 104 can be the Internet, any private network, or a combination of networks. The host 102 is configured to address and transmit ICMP traffic (e.g., one or more ICMP Request Messages) via the WAN 104 to one or more example servers, such as the first server 112 and/or a second server 114. The host 102 is further configured to receive ICMP traffic (e.g., one or more ICMP Response Messages) via the WAN 104, such as from the first server 112, the second server 114 and/or the ICMP proxy device 108. The servers 112, 114 are illustrated for example purposes. There may be fewer or more servers than the servers 112, 114 of the computer system 100 illustrated in FIG. 1.

The router or switch 106 is operationally connected the WAN 104 and to the LAN 110. The router 106 is configured to route the ICMP traffic (e.g., ICMP Request Messages) received over the WAN 104 from the host 102 via the LAN 110 to the first server 112 and/or the second server 114. The router 106 is further configured to route the ICMP traffic (e.g., ICMP Response Messages) received over the LAN 110, such as from the first server 112 and/or the second server 114, to the host 102 via the WAN 104.

The example servers 112, 114 are operationally connected to the LAN 110. In some embodiments of the example computer system 100, the router or switch 106 is configured to allow only some or all types of ICMP traffic (e.g., ICMP Request Messages) received over the WAN 104 from the host 102 to reach the first server 112 and/or the second server 114. For example, the router or switch 106 can allow all ICMP traffic from the WAN 104 to reach the first server 112 and/or the second server 114, or the router or switch 106 can block certain ICMP traffic received from the WAN 104 based on ICMP traffic type, e.g., filtering certain ICMP traffic types from being forwarded to the first server 112 and/or the second server 114.

Although not shown in the computer system 100 of FIG. 1, the LAN 110 can include a plurality of sub-networks (subnets). For example, the first server 112 and/or the second server 114 can be operationally connected to one subnet or to different subnets of the LAN 110. In certain embodiments, the router or switch 106 can allow ICMP traffic from the WAN 104 only to some or all of the subnets of the LAN 110, and/or the router or switch 106 can allow certain ICMP traffic types to one subnet (or set of subnets), while allowing other ICMP traffic types to another subnet (or set of subnets).

In other embodiments of the example computer system 100, the router or switch 106 is configured to re-route some or all ICMP traffic received via the WAN 104 (e.g., from the host 102) and addressed to the first server 112 and/or the second server 114, to the ICMP proxy device 108, as will be described below in greater detail. For re-routing purposes, the router or switch 106 can maintain a server re-routing list (not shown) including information concerning servers (e.g., server addresses, subnet addresses and traffic types) for which ICMP traffic from the WAN 104 is to be re-routed to the ICMP proxy device 108, e.g., the first server 112 and/or the second 114 for which ICMP traffic received via the WAN 104 from the host 102 is to be re-routed to the ICMP proxy device 108.

The router or switch 106 can continue to route certain ICMP traffic (based on ICMP traffic types) and other traffic (e.g., IP traffic) received over the WAN 104 without re-routing this type of traffic to the ICMP proxy device 108. The router or switch 106 can further allow propagation of ICMP traffic (e.g., ICMP Request and Response Messages) received via the LAN 110 from the proxy device 108 to the first server 112 and/or the second server 114.

As further shown in FIG. 1, the ICMP proxy device 108 is operationally connected to the router or switch 106. The ICMP proxy device 108 can be a server that is connected to the router or switch 106 directly, via the LAN 110, or via any other network. The ICMP proxy device 108 is configured to provide protection to or secure the first server 112 and/or the second sever 114 from the host 102.

The ICMP proxy device 108 includes a receive module or 116, a protection determination module 118, a response module 120, and an availability status update module 122. The receive module 116 is configured to receive ICMP traffic (e.g., ICMP Request Messages) addressed by the host 102 to the first server 112 and/or the second sever 114, and re-routed by router 106 to the ICMP proxy device 108. The response module 120 is configured to answer the ICMP traffic (e.g., ICMP Request Messages) of the host 102 with ICMP traffic (e.g., ICMP Response Messages) as if it were the first server 112 and/or the server 114. For example, the ICMP Response Messages can be configured as originating from the first server 112 and/or the server 114, e.g., addressed as originating from the first server 112 and/or the server 114.

The protection determination module 118 is configured to determine whether the ICMP proxy device 108 is to provide protection to or secure the first server 112 and/or the second sever 114 from the host 102. For example, the protection determination module 118 can access a server protection list (not shown) of protected servers. Specifically, the ICMP proxy device 108 can maintain the server protection list of servers that are to be protected or secured by the ICMP proxy device 108. The server protection list can be similar to or different than the server re-routing list maintained by the router 106. In some embodiments, one server (e.g., the first server 112) can take advantage of ICMP proxy 108, while another server (e.g., the second server 114) can continue to receive and answer ICMP traffic of the host 102 directly, e.g., ICMP Request Messages not re-routed by the router 106. In alternate embodiments, any one or both of the servers 112, 114 can be protected by ICMP proxy 108.

The availability status update module 122 is configured to perform an availability check for the presence of the first server 112 and/or the second server 114 protected or secured by the ICMP proxy device 108, and further configured to update the availability status of the of the first server 112 and/or the second server 114 in the server protection list maintained by the ICMP proxy device 108. For example, the availability status update module 122 can direct ICMP Request Messages to and receive ICMP Response Messages from the first server 112 and/or the second server 114 in order perform the availability check for the presence of the first server 112 and/or the second server 114. The router or switch 106 can route this ICMP traffic between ICMP proxy device 108 and the first server 112 and/or the second server 114 over the LAN 110.

The availability check can be performed regularly (e.g., at predetermined times) or at a time that ICMP traffic from the host 102 is received by the ICMP proxy device 108 from the router 106. In some embodiments, when the availability status update module 122 of ICMP proxy device 108 determines the first server 112 has failed, became unavailable or otherwise inoperable, the ICMP proxy device 108 can increase the availability status checking (polling) of the first server 112 to update the status as soon as first server 112 becomes available again.

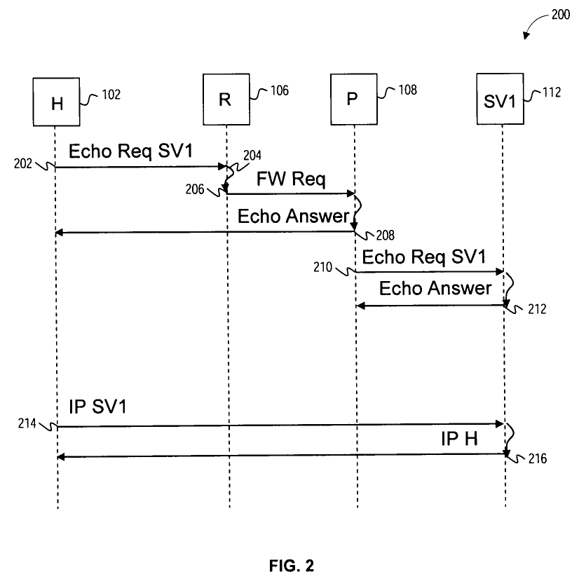

FIG. 2 shows an example process flow 200 of the host 102 performing a direct availability status request (e.g., ICMP Echo request) addressed to the first server 112 protected by the ICMP proxy 108 in the computer system 100 of FIG. 1. The first server 112 is shown as an example and direct availability status requests to other servers can be accomplished in a similar manner. Specifically, the ICMP proxy 108 can be configured to protect any one or more of the servers 112, 114, as well as any other servers in the computers system 100 that are set forth in the server protection list maintained by the ICMP proxy 108.

The process flow 200 starts at operation 202 where the host 102 performs an ICMP Echo request (e.g., transmits an ICMP Echo request packet) addressed to the first server 112. At operation 204, the router 106 receives the ICMP Echo request packet and checks the destination address of the ICMP Echo request packet against the server re-routing list maintained by the ICMP proxy device 108. If the destination address is in the server re-routing list, at operation 206, the router 106 re-routes the ICMP Echo request packet to the ICMP proxy device 108 instead of forwarding the ICMP Echo request packet to first server 112. However, packets based on other protocols can continue to be forwarded to and received from the first server 112, as shown at operations 214, 216. For example, any IP request packets from the host 102 can be forwarded by the router 106 to the first server 112 and any response packets from first server 112 can be forwarded by the router 106 to the host 102.

At operation 208, the ICMP proxy device 108 answers with an ICMP Echo response packet addressed to the host 102 with a last availability status maintained for the first server 112, such that the ICMP Echo Response packet is addressed to the host 102 from the first server 112. Specifically, the source IP address of the ICMP Echo response message is the IP of the first server 112 and not the IP of the ICMP proxy device 108, as would be the case in a normal ICMP Echo response from the ICMP proxy device 108 to the host 102.

At operations 210 and 212, the ICMP proxy device 108 performs regular availability status checking (polling) of the servers in the server protection list maintained by the ICMP proxy 108. For example, the ICMP proxy device 108 regularly checks (polls) the availability status of the first server 112 and refreshes the availability status after a specific ICMP Echo request received from the router or switch 106. Such availability status checking reflects real latency as both the ICMP proxy device 108 and the first server 112 are generally in the same area. If the first server 112 fails, becomes unavailable or otherwise inoperable after the regular availability status checking, the refresh performed via subsequent availability status checking facilitates an ICMP Echo Response with the refreshed or updated availability status via a next ICMP Echo request.

The foregoing availability status checking (polling) is generally sufficient because very often more than one ICMP Echo request (ping) is performed so that the requesting host 102 will receive the updated status after such a failure of the first server 112. In some embodiments, the ICMP proxy device 108 can increase the frequency of the availability status checking (polling) of the first server 112 after determination that the first server 112 has failed, became unavailable or otherwise inoperable, in order to update the status of first server 112 more quickly. After the availability status checking indicates that the first server 112 is once again available or operable, the previous or less frequent availability status checking (polling) of the first server 112 can be resumed.

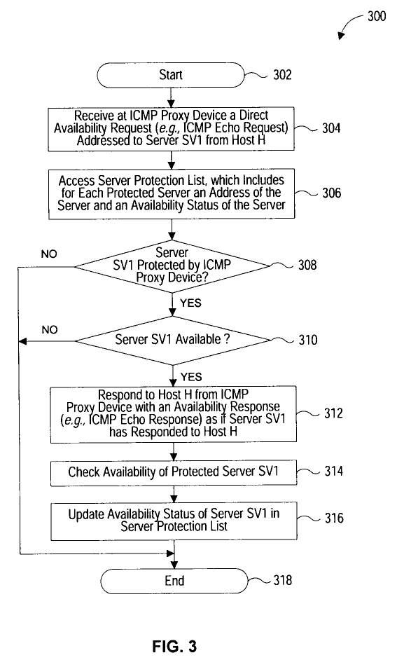

FIG. 3 is a flowchart of an example method 300 of proxying a direct availability status request (e.g., ICMP Echo request) by the ICMP proxy device 108 in accordance with FIGS. 1 and 2. The example method 300 starts at operation 302. At operation 304, the ICMP proxy device 108 receives a re-routed or re-directed direct availability status request (ICMP Echo request packet) addressed by the host 102 to the first server 112. The re-routing of the ICMP Echo request packet can be accomplished by the router 106, as described herein. At operation 306, the ICMP proxy device 108 accesses the server protection list, which can include for each protected server an address of the protected server and an availability status associated with the address of the protected server.

At operation 306, the ICMP proxy device 108 accesses its server protection list in order to determine whether the ICMP proxy device 108 is to protect the first server 112. The ICMP proxy device can accomplish this by comparing the destination address of the ICMP Echo request packet against server addresses stored by the ICMP proxy device 108 in the server protection list. As stated above, the server protection list can maintain for each protected server, its address and availability status. The availability status can be represented by a Boolean value: (1) when server is available; and (0) when the server is not available. Other availability statuses and respective representative values can be maintained.

At operation 308, a determination is made whether the first server 112 is protected by the ICMP proxy device 108. If it is determined that the destination address of the first server 112 is not in the server protection list, the ICMP proxy device 108 does not respond to the ICMP Echo request of the host 102, and the method ends at operation 318. Alternatively, if it is determined that the destination address of the first server 112 is in the server protection list, at operation 310, the ICMP proxy device 108 determines whether the availability status associated with the destination address indicates that the first server 112 is available.

If at operation 310, it is determined that the first server 112 is not available, the method 300 continues at operation 318, where the method 300 ends. No direct availability response (e.g., ICMP Echo Response) is transmitted, as would be the case if the first server 112 were answering direct availability requests on its own. Alternatively, if it is determined that the first server 112 is available, the method 300 continues at operation 312, where the ICMP proxy device 108 answers the host 102 with an availability status response (e.g., ICMP Echo Response) as if the availability status response were from the first server 112, e.g., the availability status response addressed from the first server 112 to the host 102. The availability status response indicates the availability status of the first server 112, as indicated in the server protection list.

At operation 314, the ICMP proxy device 108 checks the availability status of the protected first server 112. For example, the ICMP proxy device 108 transmits an ICMP Echo request to the first server 112 and receives an ICMP Echo Response from the first server 112. Thereafter, at operation 316 ICMP proxy device 108 updates the availability status of the first server 112 in the server protection list. For example, the ICMP proxy device 108 updates the availability status in the server protection list with the availability status in the ICMP Echo Response. Operations 314, 316 can be performed once or regularly, such as every few seconds, minutes or other frequency periods, to continue updating the availability status of the first server 112, as long as first server 112 remains available. Thereafter, the method 300 ends at operation 318.

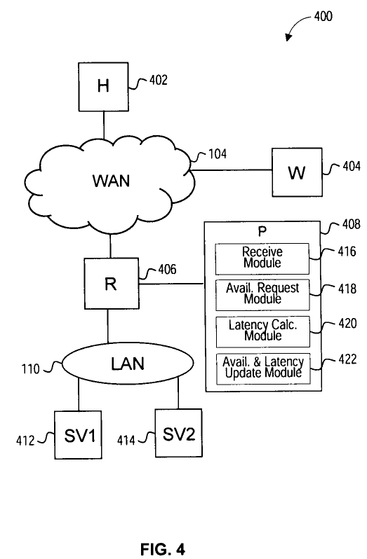

FIG. 4 is a high-level diagram of an example computer system 400. The computer system 400 includes a host (H) 402, a web server (W) 404, a router or switch (406), an ICMP proxy device (P) 408, a first server (SV1) 412 and a second server (SV2) 414. The computer system 100 further includes a wide area network (WAN) 404 and a local area network (LAN) 410.

As shown in the computer system 400, the host 402 is operationally connected to the WAN 104. The host 402 is configured to address and transmit hypertext transfer protocol (http) traffic (e.g., one or more http Request Messages) via the WAN 104 to an http or web server 404 operationally connected to the WAN 104. The host 402 is further configured to receive http traffic (e.g., one or more http Response Messages) via the WAN 104 from the web server 404. For example, the host 402 can request the web server 404 to check the availability status (and determine latency) of a first server 412 and/or a second server 414, as will be described below.

In some embodiments, the web server 404 can also include an availability/latency module (not shown) that can issue availability status requests (e.g., one or more http Request Messages) and can receive one or more http Response Messages associated with availability status requests, similar to or different than the requests/responses associated with the host 402, to check availability of and determine latency between web server 404 and first server 412 and/or the second sever 414, as will be described in greater detail below.

The router or switch 406 is operationally connected the WAN 104 and to the local area network (LAN) 110. The router or switch 406 is configured to route http traffic (e.g., one or more http Request/Response Messages) between the web server 404 and the ICMP proxy device 408 over the WAN 104, concerning, for example, the availability status(es) of the first server 412 and/or a second server 414, which are operationally connected to the LAN 110, and, in various embodiments, the host 402 or the web server 404 connected to the WAN 104.

The router or switch 406 is further configured to route ICMP traffic (e.g., ICMP Echo Request/Response Messages) over the LAN 110 between the ICMP proxy 408, the first server 412 and/or the second server 414. In some embodiments, the router or switch 406 is configured to route ICMP traffic (e.g., ICMP Echo Request/Response Messages) over the WAN 104 between the ICMP proxy 408 device and the host 402. In other embodiments, the router or switch 406 is configured to route ICMP traffic (e.g., ICMP Echo Request/Response Messages) between the ICMP proxy 408 device and the web server 404.

As shown in FIG. 4, the ICMP proxy device 408 is operationally connected to the router or switch 406. The ICMP proxy device 408 can be a server that is connected to the router or switch 406 directly, via the LAN 110, or via any other network. The ICMP proxy device 408 is configured to check the availability status of first server 112 and/or the second sever 114, and, in various embodiments, the host 102 or the web server 404, as well as end-to-end latency in connection with an http availability request from the host 402 to the web server 404 (e.g., http SV1@W) or from the web server. The availability status and latency associated with the first server 112 and/or the second sever 114 can be periodically checked and maintained by ICMP proxy device 408, as will be described hereinbelow. The ICMP proxy device 408 includes a receive module 416, an availability request module 418, a latency calculation module 420 and an availability and latency update module 422.

The receive module 416 is configured to receive the http availability request or parameters associated with the http availability request from the web server 404, as a result of an availability status request by the host 402 or by the web server 404. Such http availability request or parameters can include an indication of whether the host 402 or the web sever 404 generated or initiated the request. Based on the received http availability request or parameters associated therewith, the availability request module 418 is configured to perform an availability status check of the first server 412 and/or the second server 414. For example, availability request module 418 can transmit ICMP Echo Request messages to and receive ICMP Echo Response messages from the first server 412 and/or the second server 414. In addition, based on the received http availability request or parameters associated therewith, the availability request module 418 is also configured in various embodiments to perform an availability status check of the host 402 or of the web server 404. For example, the availability request module 418 can transmit an ICMP Echo Request message and receive ICMP Echo Response message from the host 402 or from the web server 404.

The latency calculation module 420 is configured to calculate latency with respect to the ICMP Echo Request/Response messages associated with the availability status check of the first server 412 and/or the second server 414. The latency calculation module 420 is also configured to calculate latency with respect to the ICMP Echo Request/Response messages associated with the availability status check of the host 402 or of the web server 404. The latency calculation module 420 is further configured to determine a total latency concerning ICMP Echo Request/Response messages with respect to the first server 412 and/or the second server 414, and the ICMP Echo Request/Response messages with respect to the host 402 or web server 404. For example, this determination can provide an end-to-end latency between the host 402 and the first server 412, or between the web server 404 and the first sever 412. Such latency calculations and total latency determinations can be performed in connection with other servers, such as the second server 414.

In some other embodiments, the ICMP proxy device 408 can maintain a server management list (not shown), which can similar to the server protection list described above in relation to the computer system 100 of FIG. 1. For example, the server management list can include a list of managed servers, such as servers 412, 414. The server management list can maintain for each managed server, its address, availability status and latency (e.g., latency between the ICMP proxy device 408 and first server 412, or the ICMP proxy device 408 and the second server 414). In such other embodiments, the availability request module 418 can obtain the availability status and the latency calculation module 420 can obtain the latency from the server management list.

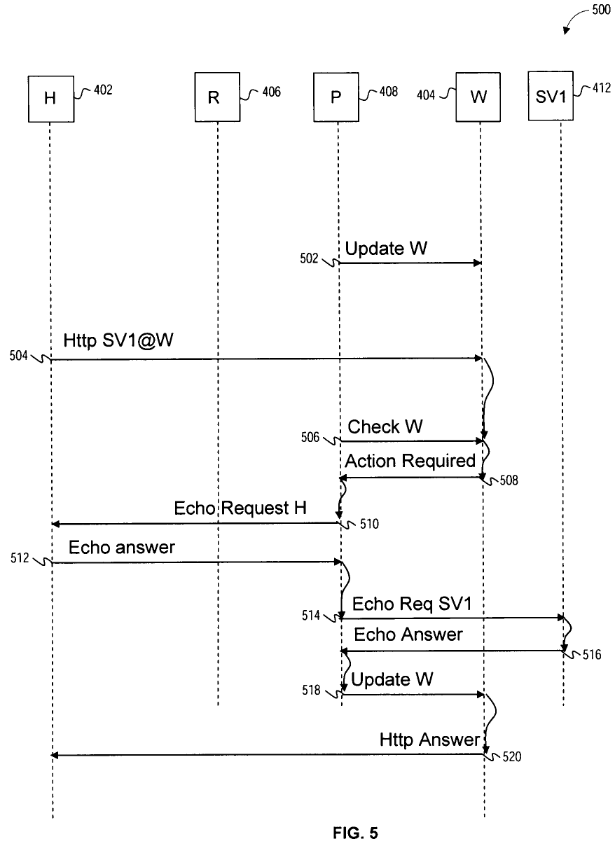

FIG. 5 shows an example process flow 500 of the host 402 performing an indirect availability request (e.g., http Availability Request) via the web server 404 of FIG. 4. In some embodiments, as shown at operation 502, the ICMP proxy device 408 regularly checks the availability status(es) of all servers for which it acts as a proxy and updates the web server 404 with these availability status(es). The availability status checking can be performed in a similar fashion to operations shown at 514 and 516, which are described below. The web server 404 can generate a web page including the updated status(es) that can be transmitted, for example, to the host 402 for display.

In some embodiments, there can be a need for more complex requests with different maximum transmission unit (MTU) or packet lengths, type of service (TOS) byte or other packet parameter or quantities of packets. In such other embodiments, at operation 504, the host 402 transmits an indirect availability request for the first sever 412 to the web server 404 (e.g., http SV1@W).

At operation 506, the ICMP proxy device 408 polls the web server 404 to obtain a new indirect availability request. At operation 508, the indirect availability request or parameters of the request are transmitted from the web server 404 to the ICMP proxy device 408. In some embodiments, instead of polling, the web server 404 can directly request the ICMP proxy device 408 to perform the indirect availability request by transmitting the indirect availability request or parameters of the request to the ICMP proxy device 408.

At operation 510, the ICMP proxy device 408 transmits an ICMP Echo request to the host 402 and receives an ICMP Echo Response from the host 402 at operation 512. At operation 514, the ICMP proxy device 408 also transmits an ICMP Echo request to the first server 412 and receives an ICMP Echo Response from the first server 412 at operation 516. The order of the request/response operations 510, 512 and 514, 516 and can be modified so that operations 514, 516 are performed before operations 510, 512.

As described herein with reference to FIG. 4, the ICMP proxy device 408 can maintain a server management list that includes for each managed server (e.g., the first server 412) its address, availability status and latency (e.g., latency between the ICMP proxy device and first server 412. Thus, the availability status and latency of the first server 412 can be obtained from the server management list, rather than perform operations 514, 516 at the time of poll of or request from the web server 404. The availability status and latency for the first server 412 can be updated in the server management list when the ICMP proxy device 408 performs its regular checks of the servers for which it acts as a proxy (e.g., the first server 412) at operation 502.

At operation 518, the ICMP proxy device 408 updates the web server 404 with the availability statuses of the host 402 and the first server 412. In some embodiments, the ICMP proxy device 408 can also calculate and then update the web server 404 with end-to-end latency from the host 402 to the ICMP proxy device 408 in connection with the indirect availability request. The web server 404 can store the latency for the requesting host 402 against the first server 412 for further network management use or other purpose. At operation 520, the web server 404 transmits availability response (http Response Messages) to the host 402 indicating the availability statuses of the host 402 and the first server 412 and the end-to-end latency.

In some embodiments, the method 500 of FIG. 5 can be performed based on the web server 404 performing an indirect availability request (e.g., http Availability Request) to the ICMP proxy device 408, such as via the availability/latency module of the web server 404 described herein with reference to FIG. 4. In these embodiments, operations 504, 520 can be omitted and the indirect availability request or parameters thereof can include an indication of whether the indirect availability request is generated or initiated by the host 402 or the web server 404. Based on the indication, the ICMP proxy device 408 can perform operations 510, 512 against the web server 404 instead of the host 402, and can also perform operation 518 to calculate and update end-to-end latency from the web server 404 to the ICMP proxy device 408 instead of from the host 402 to the ICMP proxy device 408.

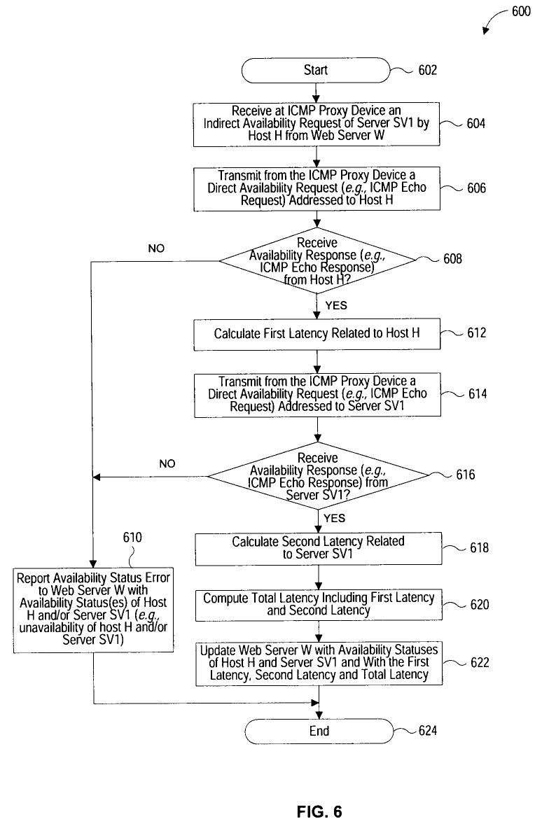

FIG. 6 is a flowchart of an example method 600 of proxying an indirect availability status request (e.g., http Availability request) via the ICMP proxy device 408 in accordance with FIGS. 4 and 5. The method 600 starts at operation 602. At operation 604, the ICMP proxy device 408 receives from the web server 404 an indirect availability status request of the host 402 concerning the first server 412.

At operation 606, the ICMP proxy device 408 transmits a direct availability request (e.g., ICMP Echo Request) addressed to host 402. At operation 608, the ICMP proxy device 408 determines whether an availability response (e.g., ICMP Echo Response) has been received from the host 402.

If at operation 608 it is determined that the availability response has not been received from the host 402, then the method 600 continues at operation 610, where the ICMP proxy device 408 reports an availability status error to the web server 404, indicating the non-availability status of the host 402. The method 600 ends at operation 624. Alternatively, if at operation 608 it is determined that the availability response has been received from the host 402, the method 600 continues at operation 612, where the ICMP proxy device 408 calculates a first latency related to the request/response associated with the host 402.

At operation 614, the ICMP proxy device 408 further transmits a direct availability request (e.g., ICMP Echo Request) addressed to the first server 412. At operation 616, the ICMP proxy device 408 determines whether an availability response (e.g., ICMP Echo Response) has been received from the first server 412.

If at operation 616 it is determined that the availability response has not been received from the first server 412, then the method 600 continues at operation 610, where the ICMP proxy device 408 reports an availability status error to the web server 404, indicating the availability status of the host 402 and the non-availability status of the first server 412. The method 600 ends at operation 624. Alternatively, if at operation 616 it is determined that the availability response has been received from the first server 412, the method 600 continues at operation 618, where the ICMP proxy device 408 calculates a second latency related to the request/response associated with the first server 412.

In some embodiments, operations 614-618 can be substituted by retrieving the server availability status and the latency associated with the first server 412 from a server management list maintained by the ICMP proxy device 408, as described hereinabove in reference to FIGS. 4 and 5.

At operation 620, ICMP proxy device 408 computers a total (end-to-end) latency between the host 402 and the first server 412, which includes the first latency and the second latency. At operation 622, the ICMP proxy device 408 updates the web server 404 with the availability statuses of the host 402 and the first server 412, the first latency, the second latency and the total (end-to-end) latency. If only the first latency or the second latency is available, then special indications are used in association with the unavailable latency as well as the total latency. Thereafter, the method ends at operation 624.

The foregoing example description of FIG. 6 is based on the indirect availability status request received from the host 402, which is external to the web server 404. In some embodiments, the availability status request can be generated or initiated by the web server 404 and not by the host 402, as described herein with reference to FIGS. 4 and 5. In these embodiments, between operations 604, 606 a determination can be made based on an indication in the availability status request of whether the availability status request was generated/initiated by the host 402 or by the web server 404. If it is indicated that the availability status request is generated/initiated by the host 402, operations 606-622 are performed as described above in reference to FIG. 6. Alternatively, if it is determined that the availability status request is generated/initiated by the web server 404, operations 606, 608, 610, 612, 620 and 622 are performed in view of the web server 404 instead of the host 402.

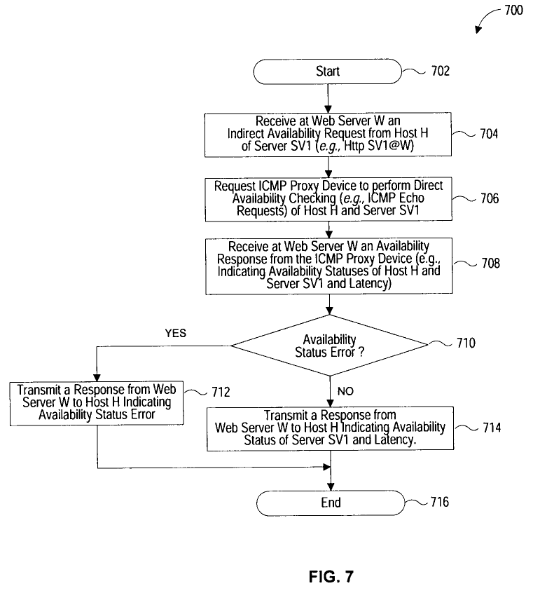

FIG. 7 is a flowchart of an example method 700 of performing an indirect availability status request (e.g., http Availability request) via the web server 404 in accordance with FIGS. 4 and 5. The method starts at operation 702. At operation 704, the web server 404 receives an indirect availability request from the host 402 concerning the first server 412 (e.g., http SV1@W). At operation 706, the web server 404 requests the ICMP proxy device 408 to perform direct availability checking (e.g., http Request/Response).

At operation 708, the web server 404 receives from the ICMP proxy device 408 an availability response. The availability response can indicate availability statuses of the host 402 and the first server 412 and latencies, or can indicate availability status errors when the host 402 or the first server 412 is not available. At operation 710, the web server 404 determines whether the availability response indicates an availability status error of the host 402 or the first server 412.

If an availability status error is determined at operation 710, then the method continues at operation 712, where the web server 404 transmits an availability status response (e.g., http Availability Response) to the host 402, indicating the availability status error. Alternatively, if an availability status error is not found at operation 710, then the method continues at operation 714, where the web server 404 transmits an availability status response (e.g., http Availability Response) to the host 402, indicating availability statuses of the host 402 and the first server 412 and latencies. Thereafter, the method 600 ends at operation 716.

The availability status and latency information of operation 708 can be stored in a database or one or more files in the computer system 400 of FIG. 4 for network management purposes.

The foregoing example description of FIG. 7 is based on the indirect availability status request received by the web server 404 from the host 402, which is external to the web server 404. As described with reference to FIGS. 4-6, the availability status request can be generated or initiated by the web server 404 and not by the host 402 in some embodiments. In these embodiments, the web server 404 can generate the indirect availability status request of operation 704 rather than receiving it from the host 402. In such indirect availability status request, the web server 404 can indicate that the request is generated/initiated by the web server 404 and not by the host 402. Operations 706, 708 can be performed in view of the web server and not the host 402. Operations 710-714 can be omitted. The availability and latency can be utilized to determine and improve connectability as well as latency between the web server 404 and the first sever 412.

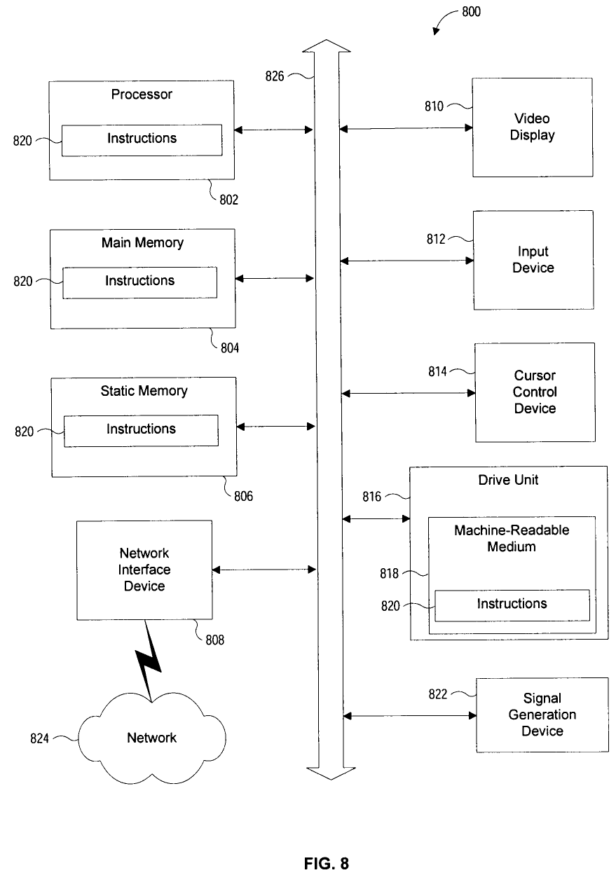

FIG. 8 is a block diagram of a general computer system 800. The computer system 800 can include a set of instructions that can be executed to cause the computer system 800 to perform any one or more of the methods or computer based functions disclosed herein with respect to FIGS. 1-7. The computer system 800, or any portion thereof, may operate as a standalone device or may be connected, e.g., using a network 824, to other computer systems or devices disclosed herein with respect to FIGS. 1-7. For example, the computer system 800 may include or be included within any one or more of the systems, networks, hosts, routers, servers, proxy devices, or any other devices disclosed herein with respect to FIGS. 1-7.

In a networked deployment, the computer system 800 may operate in the capacity of a server or a client machine in a server-client network environment, or a peer machine in a peer-to-peer (or distributed) network environment. The computer system 800 can also be implemented as or incorporated into various devices, such as a personal computer (PC), a tablet PC, a personal digital assistant (PDA), a web appliance, a communications device, a mobile device, a wireless telephone, a control system, a network router, switch or bridge, or any other machine capable of executing a set of instructions (sequential or otherwise) that specify actions to be taken by that machine. Further, while a single computer system 800 is illustrated, the term “system” shall also be taken to include any collection of systems or sub-systems that individually or jointly execute a set, or multiple sets, of instructions to perform one or more computer functions.

As illustrated in FIG. 8, the computer system 800 may include a processor 802, e.g., a central processing unit (CPU), a graphics-processing unit (GPU), or both. Moreover, the computer system 800 can include a main memory 804 and a static memory 806 that can communicate with each other via a bus 826. As shown, the computer system 800 may further include a video display unit 810, such as a liquid crystal display (LCD), an organic light emitting diode (OLED), a flat panel display, a solid state display, or a cathode ray tube (CRT). Additionally, the computer system 800 may include an input device 812, such as a keyboard, and a cursor control device 814, such as a mouse. The computer system 800 can also include a disk drive unit 816, a signal generation device 822, such as a speaker or remote control, and a network interface device 808.

In a particular embodiment, as depicted in FIG. 8, the disk drive unit 816 may include a machine or computer-readable medium 818 in which one or more sets of instructions 820 (e.g., software) can be embedded. Further, the instructions 820 may embody one or more of the methods or logic as described herein with reference to FIGS. 1-7. In a particular embodiment, the instructions 820 may reside completely, or at least partially, within the main memory 804, the static memory 806, and/or within the processor 802 during execution by the computer system 800. The main memory 804 and the processor 802 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with the various embodiments, the methods described herein may be implemented by software programs that are tangibly embodied in a processor-readable medium and that may be executed by a processor. Further, in an example, non-limited embodiment, implementations can include distributed processing, component/object distributed processing, and parallel processing. Alternatively, virtual computer system processing can be constructed to implement one or more of the methods or functionality as described herein.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, example embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

In accordance with various embodiments, the methods described herein may be implemented as one or more software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that software which implements the disclosed methods may optionally be stored on a tangible storage medium, such as: a magnetic medium, such as a disk or tape; a magneto-optical or optical medium, such as a disk; or a solid state medium, such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the disclosure is considered to include a tangible storage medium or distribution medium as listed herein, and other equivalents and successor media, in which the software implementations herein may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

Thus, an ICMP proxy device, system and methods of proxying ICMP traffic have been described. Although specific example embodiments have been described, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate example embodiment.

What is claimed is:

1. A method of proxying Internet Control Message Protocol (ICMP) traffic, the method comprising:
receiving by an ICMP proxy device a direct availability request addressed to a server from a host;
determining by the ICMP proxy device whether the server is available; and
responding to the host from the ICMP proxy device with an availability response based on the determination, such that the availability response is addressed from the server to the host.

2. The method of proxying ICMP traffic of claim 1, further comprising determining by the ICMP proxy device whether the server is protected by the ICMP proxy device.

3. The method of proxying ICMP traffic of claim 2, wherein determining whether the server is protected further comprises:
accessing a server protection list; and
determining whether a destination address of the direct availability request is in the server protection list.

4. The method of proxying ICMP traffic of claim 3, further comprising:
checking availability of the server by the ICMP proxy device; and
updating an availability status associated with the destination address in the server protection list based on the availability of the server.

5. The method of proxying ICMP traffic of claim 1, further comprising routing by a router at least some of the ICMP traffic to the ICMP proxy device according to ICMP traffic type.

6. The method of proxying ICMP traffic of claim 1, further comprising routing by a router at least some of the ICMP traffic to the server according to ICMP traffic type or sub-network associated with the server.

7. The method of proxying ICMP traffic of claim 1, further comprising filtering by the router at least some of the ICMP traffic from being forwarded to the server.

8. A system of proxying Internet Control Message Protocol (ICMP) traffic, the system comprising:
an ICMP proxy device including:
a receive module configured to receive a direct availability request addressed to a server from a host;
a protection determination module configured to determine whether the server is available; and
a response module configured to respond to the host with an availability response based the determination, such that the availability response is addressed from the server to the host.

9. The system of proxying ICMP traffic of claim 8, wherein protection determination module is further configured to determine whether the server is protected by ICMP proxy device.

10. The system of proxying ICMP traffic of claim 9, wherein to determine whether the server is protected by the proxy device, the protection determination module is configured to:
access a server protection list; and
determine whether a destination address of the direct availability request is in the server protection list.

11. The system of proxying ICMP traffic of claim 10, wherein the ICMP proxy device further includes an availability determination module configured to:
check availability of the server by the ICMP proxy device; and
update an availability status associated with the destination address in the server protection list based on the checked availability of the server.

12. The system of proxying ICMP traffic of claim 8, further comprising a router configured to route at least some of the ICMP traffic to the ICMP proxy device according to ICMP traffic type.

13. The system of proxying ICMP traffic of claim 8, further comprising a router configured to route at least some of the ICMP traffic to the server according to ICMP traffic type or sub-network associated with the server.

14. The system of proxying ICMP traffic of claim 8, further comprising a router filter at least some of the ICMP traffic from being forwarded to the server.

15. A computer-readable storage medium comprising operational instructions that, when executed by a processor, cause the processor to:
receive at an Internet Control Message Protocol (ICMP) proxy device a direct availability request addressed to a server from a host;
determine whether the server is available; and
respond to the host from the ICMP proxy device with an availability response based on the determination, such that the availability response is addressed from the server to the host.

16. The computer-readable storage medium of claim 15, further comprising operational instructions that, when executed by a processor, cause the processor to determine whether the server is protected by the ICMP proxy device.

17. The computer-readable storage medium of claim 16, wherein operational instructions that cause the processor to determine whether the server is protected further comprise operational instructions that, when executed by the processor, cause the processor to:
access a server protection list; and
determine whether a destination address of the direct availability request is in the server protection list.

18. The computer-readable storage medium of claim 17, further comprising operational instructions that, when executed by a processor, cause the processor to:
check availability of the server; and
update an availability status associated with the destination address in the server protection list based on the availability of the server.

19. The computer-readable storage medium of claim 15, further comprising operational instructions that, when executed by a processor, cause the processor to route at least some ICMP traffic to the ICMP proxy device according to ICMP traffic type.

20. The computer-readable storage medium of claim 15, further comprising operational instructions that, when executed by a processor, cause the processor to route at least some ICMP traffic to the server according to ICMP traffic type or sub-network associated with the server.

21. The computer-readable storage medium of claim 15, further comprising operational instructions that, when executed by a processor, cause the processor to filter at least some ICMP traffic from being forwarded to the server.
